(19) United States
(12) Patent Application Publication
(10) Pub. No.: US 2006/0175317 A1
(43) Pub. Date: Aug. 10, 2006

(54) Lifespan monitoring apparatus and method for a filter of an unboiled water pitcher

(75) Inventor: Shih-Yi Chang, Hsinchu City (TW)

Correspondence Address: BRUCE H. TROXELL, SUITE 1404, 5205 LEESBURG PIKE, FALLS CHURCH, VA, 22041, US

(73) Assignee: Senno Technology Inc.

(21) Appl. No.: 11/052,950

(22) Filed: Feb. 9, 2005

(51) Int. Cl. H05B 3/68

(52) U.S. Cl. 219/446.1

(57) ABSTRACT

The prevent invention discloses a lifespan monitoring apparatus and method for a filter of an unboiled water pitcher. The pitcher comprises an interior for holding a quantity of liquid, a bottom base with an orifice, a pressure-measuring device disposed in the bottom base and communicating with the orifice to measure weight of the liquid held in the interior, a microprocessor device coupled with the pressure-measuring device. The prevent invention also discloses a monitoring method comprising the following steps: measuring a first added weight of the liquid and storing a first data, transformed from the first added weight, by the microprocessor device; pouring out the liquid held in the interior; measuring a second added weight of the liquid and accumulating a second data, transformed from the second added weight, with the first data by the microprocessor device to form an accumulated data; comparing the accumulated data with a standard data. Finally, an alarm will be occurred while the accumulated data is larger than the standard data; on the contrary, while the accumulated data is smaller than the standard data, the filter is available to be used. The monitoring steps will continue being progressed, while the interior is replenished with liquid through the filter.

### FIELD OF THE INVENTION

The present invention relates to a lifespan monitoring apparatus and method for a filter of an unboiled water pitcher. More particularly, the invention relates to a monitoring apparatus and method calculating and judging the lifespan of the filter for unboiled water pitcher accurately and correctly.

### BACKGROUND OF THE INVENTION

### Description of the Related Art

Most of the human body is made up of water, H₂O, with cells consisting of 65-90% water by weight; therefore, drinking water is important to human beings in our daily life. However, owing to the fast changed industry development with each passing day, the water, such as spring water, well water and so on, we are counting on, contains so many kinds of impurities and contaminants that are necessary to be removed by boiling water so as to become potable for human beings.

The conventional unboiled water pitcher 1 in market, shown in FIG. 1, comprises a bottom base 11, used for placing, a outer shell 12, and a filter 13, wherein an interior 14, defined by the bottom base 11 and the outer shell, can hold a quantity of liquid. Since some of the impurities such as chemical components are difficult to be removed by boiling the liquid, it is necessary to utilize the filter 13 to remove chemical components completely so as to make the liquid become potable.

However, the filter 13, with limited lifespan, will lost its capability of filtering after it has been filtered a certain amount of liquid. Therefore, how to judge whether the filter 13 is out of function or not become a main issue that should be overcome. An electronic counter (not shown in FIG. 1) is disposed in the conventional pitcher 1, illustrated in FIG. 1, to count the number of times that the liquid passed through the filter 13 into the interior, but the electronic counter can't estimate accurately and correctly how much liquid has been filtered and even miscount the times induced by the miss-operation of user, causing the filtered 13 to be thrown away before its normal lifespan or causing the filter 13 to lost its capability for overusing.

Therefore, it would be advantageous to provide apparatus and method that monitor the lifespan of the filter disposed in the unboiled water pitcher more accurately and correctly for the consuming market.

### SUMMARY OF THE INVENTION

The main object of the present invention is to provide a lifespan monitoring apparatus and method for a filter of an unboiled water pitcher utilizing a pressure-measuring device to calculate the amount of liquid passing through a filter so as to achieve an objective of judging the lifespan of the filter accurately and correctly.

For the purpose to achieve the objective listed above, the prevent invention discloses a lifespan monitoring apparatus for a filter of an unboiled water pitcher. The pitcher is available to be placed through a first lateral of a bottom base. A second lateral of the bottom base and an outer shell, enclosing periphery of the second lateral, define an interior for holding a quantity of liquid. The monitoring apparatus for a filter of an unboiled water pitcher comprises, an orifice, a pressure-measuring device, and a microprocessor device. The orifice is communicated with the first lateral and the second lateral. The pressure-measuring device, disposed on the first lateral, communicates with the orifice to be capable of measuring weight of the liquid held in the interior, and transmits a data signal related to measured weight of the liquid to the microprocessor device, coupled with the pressure-measuring device, providing to receive, calculate and then transmit the data signal to a display device.

For the purpose to achieve the objective listed above, the prevent invention also discloses a monitoring method comprising the following steps:
(a) providing an unboiled water pitcher with an interior comprising a bottom base with an orifice, a pressure-measuring device communicating with the orifice to be capable of measuring weight of a liquid held in the interior, and a microprocessor device, coupled with the pressure-measuring device;
(b) measuring a first added weight of the liquid held in the interior and storing a first data, transformed from the first added weight, by the microprocessor device;
(c) pouring out the liquid held in the interior;
(d) measuring a second added weight of the liquid held in the interior and accumulating a second data, transformed from the second added weight, with the first data by the microprocessor device to form an accumulated data;
(e) comparing the accumulated data with a standard data, representing a total capacity, determined through testing, that the filter can deal with ; and
(f) an alarm occurred while the accumulated data being larger than the standard data; on the contrary, repeating the step (c) while the accumulated data being smaller than the standard data.

### BRIEF DESCRIPTION OF THE DRAWINGS

The drawings, incorporated into and form a part of the disclosure, illustrate the embodiments and method related to this invention and will assist in explaining the detail of the invention.

FIG. 1 is a schematic view illustrating a conventional unboiled water pitcher.

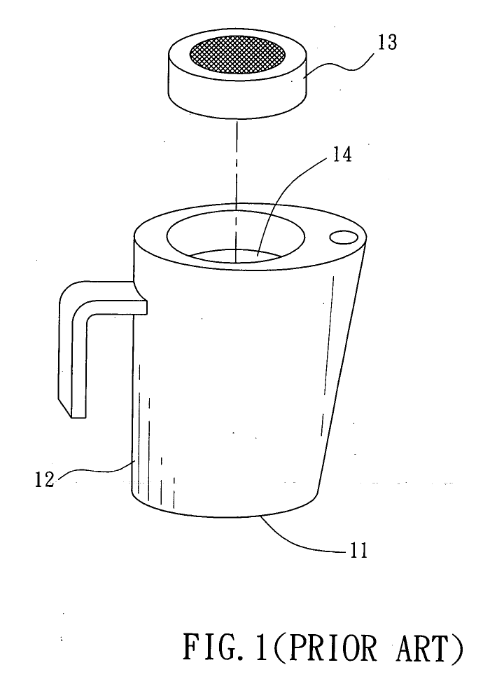

FIG. 2a is a perspective view illustrating a preferred embodiment according to the present invention.

FIG. 2b is a cross-sectional view illustrating a preferred embodiment according to the present invention.

FIG. 3 illustrates a flow chart of the method according to the present invention.

### DESCRIPTION OF THE PREFERRED EMBODIMENT

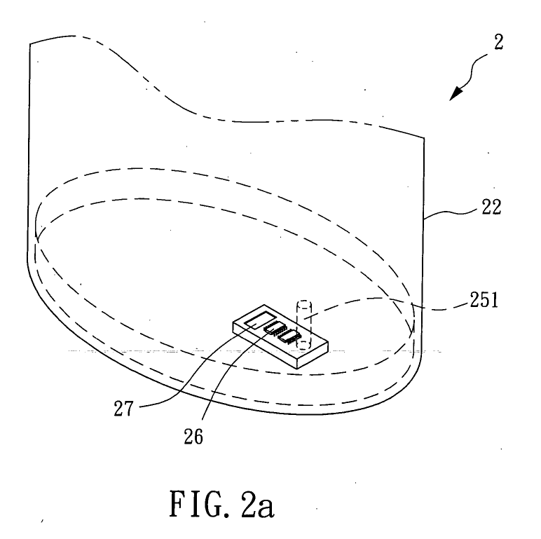

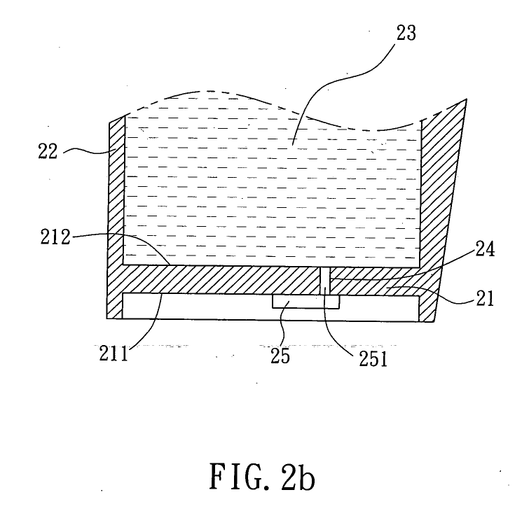

Please referring to FIG. 2a and FIG. 2b, the figures illustrate the preferred embodiment according to the present invention. In the embodiment, a filter lifespan monitoring apparatus, disposed in an unboiled water pitcher 2 being available to be placed by using a first lateral 211 of a bottom base 21 and having an interior 23 defined by an outer shell 22 and a second lateral 212 of the bottom base 21 wherein the outer shell 22 encloses periphery of the second lateral 212 for holding a quantity of liquid, comprises an orifice 24, a pressure-measuring device 25, and a microprocessor device 26.

The orifice 24, disposed in the bottom base 21, communicates with the first lateral 211 and the second lateral 212. The pressure-measuring device 25, disposed on the first lateral 211 to communicate with the orifice 24, further comprises a hose 251, arranged in the orifice 24, to allow the liquid held in the interior 23 to flow therethrough and then enter the pressure-measuring device 25.

When added liquid is filtered through a filter (not shown in figure) to the interior 23, the pressure-measuring device 25 is capable of measuring the pressure difference, induced by weight of the added liquid held in the interior 23 through the hose 251, to generate and transmit a data signal to the microprocessor device 26 which is coupled with the pressure-measuring device 25. The microprocessor device 26 can accumulate the data signal generated from the weight of liquid, measured by the pressure-measuring device 25, replenished each time in the interior 23 to an accumulated data and then transmit the accumulated data to a display device 27 which is a Liquid crystal display displaying information to user. The display device 27 is available to display the single data signal or the accumulated data. In addition, for convenient and saving manufacturing cost, the display device 27 is also available to be formed by at least one light emitting diode.

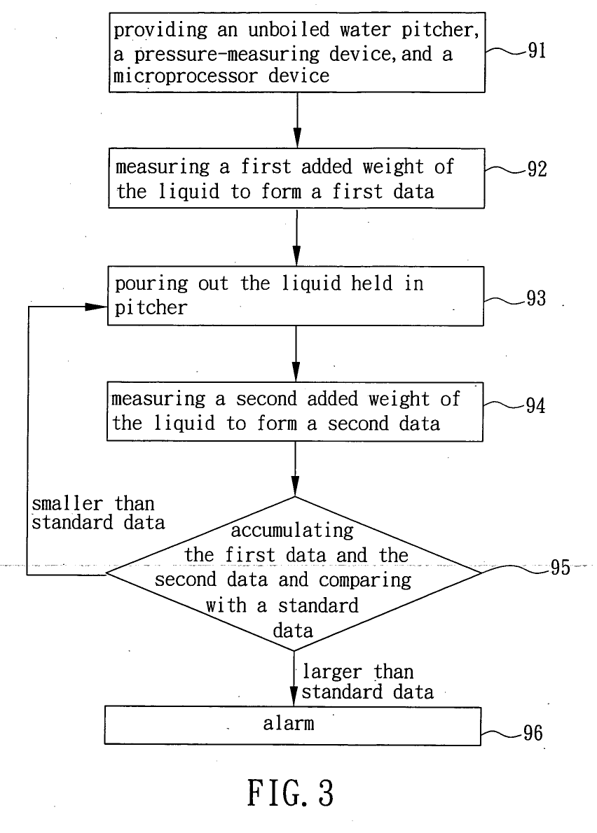

For more detail to understand the feature and objectives according to the present invention, a FIG. 3 illustrates a flow chart of the method according to the preferred embodiment. The symbols, marked in 91, 92, 93, 94, 95, and 96, illustrated in FIG. 3, refer to the monitoring method comprising the step (a) to step (f) described in the following contents:
Step (a): providing an unboiled water pitcher with an interior comprising a bottom base with an orifice, a pressure-measuring device communicating with the orifice to be capable of measuring weight of a liquid held in the interior, and a microprocessor device, coupled with the pressure-measuring device;
Step (b): measuring a first added weight of the liquid held in the interior and storing a first data, transformed from the first added weight, by the microprocessor device, wherein the first added weight is determined by calculating difference between a first weight of liquid prior held in the interior and a second weight of liquid which is a weight measured after adding a quantity of liquid through a filter into said interior containing said first weight of liquid;
Step (c): pouring out the liquid held in the interior;
Step (d): measuring a second added weight of the liquid held in the interior and accumulating a second data, transformed from the second added weight, with the first data by the microprocessor device to form a accumulated data, wherein the second added weight is determined by calculating difference between a third weight of the liquid prior held in the interior, and a fourth weight of the liquid which is a weight measured after adding a quantity of liquid through the filter into said interior containing said third weight of liquid;
Step (e): comparing the accumulated data with a standard data, determined through testing and representing a total capacity that the filter can deal with ; and
Step (f): an alarm occurred and displayed in a display device, which is a liquid crystal display or is formed by at least of on light emitting diode, while the accumulated data being larger than the standard data; on the contrary, repeating the step (c) while the accumulated data being smaller than the standard data.

If the accumulated data is smaller than the standard data, the monitoring steps will continue being progressed, while the interior is replenished with liquid through the filter.

While the present invention has been described and illustrated herein with reference to the preferred embodiment thereof, it will be understood by those skilled in the art that various changes in form and details may be made therein without departing from the spirit and the scope of the invention.

What is claimed is:

1. A filter lifespan monitoring apparatus, disposed in an unboiled water pitcher being available to be placed by using a first lateral of a bottom base and having an interior defined by an outer shell and a second lateral of said bottom base for holding a quantity of liquid, comprising:
an orifice communicating with said first lateral and said second lateral;
a pressure-measuring device, disposed on said first lateral, communicating with said orifice to be capable of measuring weight of said liquid held in said interior, and transmitting a data signal related to measured weight of said liquid; and
a microprocessor device, coupled with said pressure-measuring device, providing to receive, calculate and then transmit said data signal to a display device.

2. The monitoring apparatus according to claim 1, wherein said pressure-measuring device further comprises a hose disposed through said orifice and detecting pressure difference, induced by said liquid flowing therethrough, to measure weight of said liquid held in said interior.

3. The monitoring apparatus according to claim 1, wherein said microprocessor accumulates said data signal generated from the weight of the liquid replenished each time in said interior.

4. The monitoring apparatus according to claim 1, wherein said display device is substantially a liquid crystal display.

5. The monitoring apparatus according to claim 1, wherein said display device is substantially formed by at least a light emitting diode.

6. The monitoring apparatus according to claim 1, wherein said liquid is poured into said interior through a filter.

7. A filter lifespan monitoring method, comprising the following steps:
(a) providing an unboiled water pitcher with an interior comprising a bottom base with an orifice, a pressure-measuring device communicating with said orifice to be capable of measuring weight of a liquid held in said interior, and a microprocessor device, coupled with said pressure-measuring device;
(b) measuring a first added weight of said liquid held in said interior and storing a first data, transformed from said first added weight, by said microprocessor device;
(c) pouring out said liquid held in said interior;
(d) measuring a second added weight of said liquid held in said interior and accumulating a second data, transformed from said second added weight, with said first data by said microprocessor device to form an accumulated data;
(e) comparing said accumulated data with a standard data; and
(f) an alarm occurred while said accumulated data being larger than said standard data; on the contrary, repeating said step (c) while said accumulated data being smaller than said standard data.

8. The monitoring method according to claim 7, wherein said first added weight in said step (b) is determined by calculating difference between a first weight of liquid prior held in said interior and a second weight of liquid that is a weight after adding a quantity of liquid through a filter into said interior containing said first weight of liquid.

9. The monitoring method according to claim 7, wherein said second added weight in said step (d) is determined by calculating difference between a third weight of liquid prior held in said interior and a fourth weight of liquid that is a weight after adding a quantity of liquid through a filter into said interior containing said third weight of liquid.

10. The monitoring method according to claim 7, wherein said alarm is displayed by providing a display device.

11. The monitoring method according to claim 10, wherein said display device is substantially a liquid crystal display.

12. The monitoring method according to claim 10, wherein said display device is formed by at least a light emitting diode.
